(19) United States
(12) Patent Application Publication
(10) Pub. No.: US 2017/0021984 A1
(43) Pub. Date: Jan. 26, 2017

(54) FLUID-PRODUCT DISPENSER

(71) Applicant: APTAR FRANCE SAS, Le Neubourg (FR)

(72) Inventors: Laurent DECOTTIGNIES, Cergy (FR); Patrick MULLER, Saint Aubin Sur Gaillon (FR)

(73) Assignee: APTAR FRANCE SAS, Le Neubourg (FR)

(21) Appl. No.: 15/302,193

(22) PCT Filed: Apr. 14, 2015
(86) PCT No.: PCT/FR2015/050988

§ 371 Date: Oct. 6, 2016

(30) Foreign Application Priority Data
Apr. 16, 2014 (FR) 1453411

(51) Int. Cl. B65D 47/24; B05C 17/01; B05C 17/005

(52) U.S. Cl. CPC B65D 47/244; B05C 17/00576; B05C 17/0136

(57) ABSTRACT

A fluid dispenser comprising a fluid reservoir (R) in which the fluid is stored under pressure, and a fluid outlet valve that is actuatable from a closed position to an open position so as to define a dispenser orifice (62), the outlet valve including a movable member (51) that bears in sealed manner against a seat (63) in the closed position and that is not in contact with the seat (63) in the open position, the movable member (51) being axially movable and resiliently biased against the seat (63), the dispenser also comprising an actuator member (61) for moving the movable member (51) between the closed and open positions, the fluid dispenser being characterized in that the dispenser orifice (62) and the actuator member (61) are both formed by a rotary disk (6).

The present invention relates to a fluid dispenser comprising a fluid reservoir in which the fluid is stored under pressure, and a fluid outlet valve that is actuatable from a closed position to an open position so as to define a dispenser orifice. The outlet valve includes a movable member that bears in sealed manner against a seat in the closed position and that is not in contact with the seat in the open position. The dispenser also comprises an actuator member for moving the movable member between the closed and open positions, the movable member being axially movable and resiliently biased against the seat. This type of dispenser is widely used in the fields of cosmetics, perfumery, pharmacy, and food, for dispensing fluids that are viscous to a greater or lesser extent.

In the prior art, numerous dispensers are already known that are fitted with an actuator member that is pressed so as to open an outlet valve allowing a fluid stored under pressure in a reservoir to be dispensed. In particular, aerosols exist that contain a propellant gas. In general, they are fitted with a dispenser valve that is fitted with a valve rod that is pressed axially or laterally. Dispensers are also known having a reservoir that is fitted with a pusher piston that is biased by a spring, for example. That type of dispenser is also fitted with an outlet valve or with a dispenser valve. In entirely general manner, most outlet valves or valve members are fitted with a return spring, and actuation of the actuator member requires the stiffness of the return spring to be overcome.

The present invention wishes to break radically with traditional techniques in order to propose an outlet valve for which the force necessary to move the actuator member is smaller, while guaranteeing complete sealing. The present invention also wishes to break with the usual hand movement that consists in axially depressing or laterally tilting a valve rod. The present invention also seeks to depart from any unitary dosage, so as to offer dispensing for as long as the actuator member continues to be actuated. Finally, the present invention seeks to improve significantly the dispensing of creams that are packaged in pots.

To achieve the various objects, the present invention proposes that the dispenser orifice and the actuator member are both formed by a single rotary disk. The disk may be completely or substantially plane, e.g. it may be slightly concave, and the dispenser orifice is preferably arranged at the center of the disk, about which the disk turns. In other words, the axis about which the disk is turned passes through the dispenser orifice. Thus, when the disk is turned, the outlet valve opens with the movable member lifting off its seat so as to reach its open position. The dispenser orifice is thus released, and the fluid under pressure can exit from the reservoir so as to spread over the disk, around the dispenser orifice. Once the user releases the disk, it performs a reverse angular stroke, driven by a return spring. As a result, on each actuation, the rotary disk performs the same angular stroke, then returns to its initial start position.

In an advantageous embodiment, the rotary disk includes a cam element so as to transform the rotary movement of the disk into axial movement of the movable member. Advantageously, the cam element comprises a plurality of cam sectors, each defining a slope in the shape of a circularly-arcuate segment. In addition, the movable member may be provided with a cam member that co-operates with the cam element of the rotary disk. Advantageously, the cam member defines as many circularly-arcuate cam profiles as there are cam sectors. It can thus be said that the dispenser incorporates a cam system that makes it possible to transform the turning of the disk into an axial movement of the movable member that is transverse or perpendicular to the plane of the disk. The cam or movement-transformation system acts between the rotary disk and the movable member of the outlet valve so as to lift the movable member off its seat.

In another practical embodiment, the movable member may be formed by a lid that is mounted on the reservoir, the rotary disk being rotatably mounted on the lid to turn about the movable member, the rotary disk advantageously being held on the lid by a hoop. Instead of the hoop, it is possible to envisage that the peripheral edge of the disk is snap-fastened in slack manner in a housing formed by the lid, allowing the disk to turn. Advantageously, a return spring that is advantageously flat and made of plastics material, acts between the rotary disk and the lid so as to return the rotary disk into its initial position after each turn. When the dispenser is in the form of a pot, the lid is relatively flat or plane, like the disk, such that the return spring must also be flat in order to be interposed between the lid and the disk. The return spring makes it possible not only to limit the angular stroke of the disk relative to the lid, but also makes it possible to return the disk to its start position.

In a practical embodiment, the movable member comprises a pin that is suitable for engaging in sealed manner in the seat that is formed by the rotary disk, the pin being surrounded by a cam member that is itself surrounded by resilient means, advantageously in the form of flexible tabs that urge the pin resiliently against the seat. Preferably, the seat forms the dispenser orifice such that the pin can be seen from the outside face of the disk.

According to another characteristic of the invention, the reservoir includes a pusher piston that slides in leaktight manner in a slide cylinder, the pusher piston being biased by resilient means selected from springs, foams, and gases.

The spirit of the invention resides in the wall that forms the dispenser orifice being a rotary disk that serves to actuate the fluid outlet valve. The disk is preferably flat or plane and turns about the dispenser orifice. Given that the disk offers non-negligible surface area, it is possible to apply visual marking on the disk, such as arrows for example, so as to inform the user that it is necessary to turn the disk in order to dispense the fluid.

The invention is described below more fully with reference to the accompanying drawings, which show an embodiment of the invention by way of non-limiting example.

In the figures:

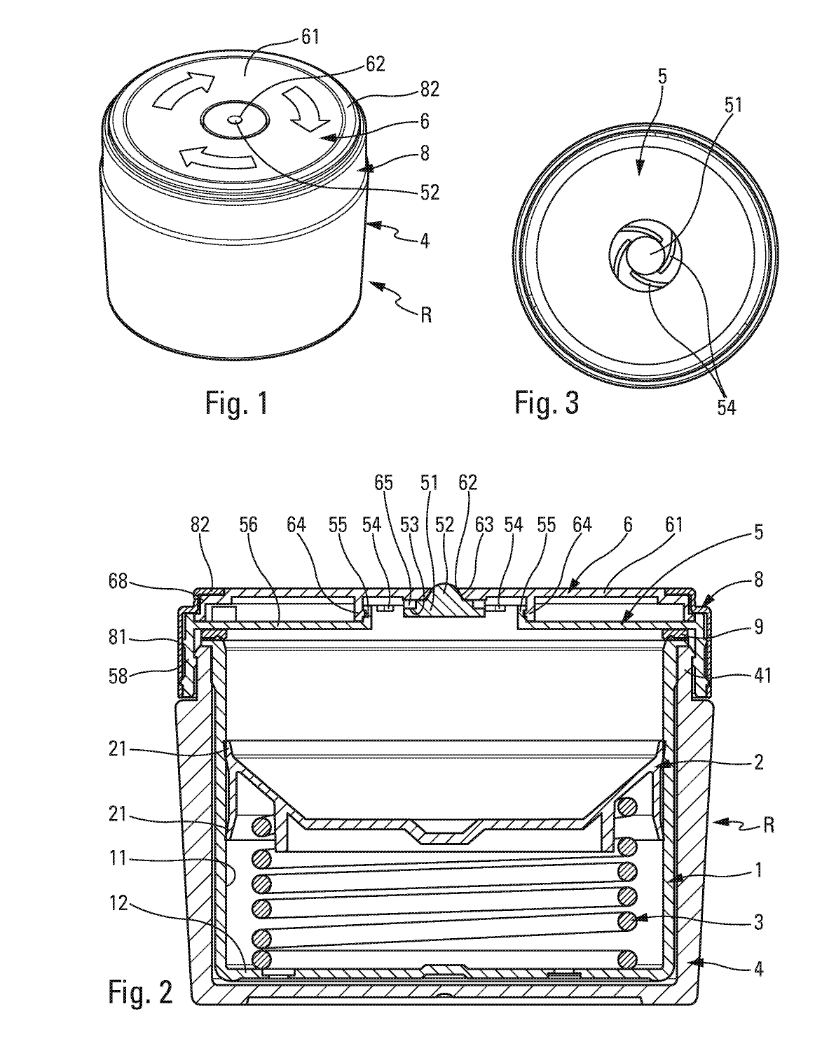

FIG. 1 is a substantially life-size perspective view of a fluid dispenser of the invention;

FIG. 2 is a larger-scale vertical section view through the FIG. 1 dispenser;

FIG. 3 is a plan view of the inside of the FIG. 1 dispenser; and

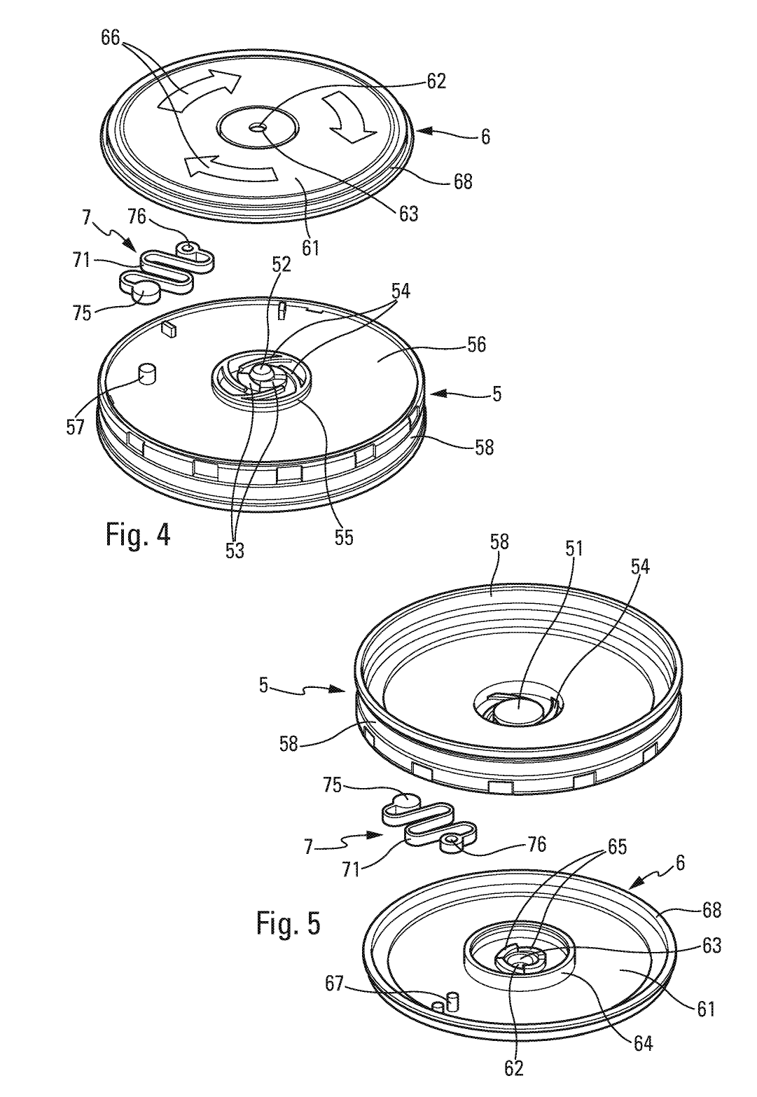

FIGS. 4 and 5 are exploded perspective views of a portion of the dispenser in FIGS. 1 to 3.

Since it is a pot, the dispenser shown in the figures in order to illustrate the present invention is of a particular type that is characterized by its short and stocky shape. It can also be said that the pot is characterized by a top face that is substantially plane with a diameter that corresponds substantially to the diameter of the reservoir.

In the embodiment shown, the fluid reservoir R is associated with a lid 5 that is mounted on a neck 41 in stationary and leaktight manner, e.g. by interposing a neck gasket 8. In this embodiment, the reservoir R presents a configuration that is somewhat particular, since it comprises an inner container 1 that is arranged inside an outer pot 4. The inner container 1 internally includes a slide cylinder 11 and a bottom wall 12. The container 1 also contains a pusher piston 2, e.g. provided with two sealing lips 21. In this embodiment, the pusher piston 2 is biased by resilient means that are in the form of a spring 3 that may be a coil spring, and that bear firstly against the bottom wall 12 and secondly beneath the pusher piston 2. It can easily be understood that the force of the spring 3 pushes the pusher piston 2 in such a manner as to exert pressure on the fluid that is present above the follower piston 2. By way of example, the inner container 1 may form a collar against which the neck gasket 8 bears and under which the neck 41 is formed that comes into engagement with the lid 5 so as to close the reservoir R.

Without going beyond the ambit of the invention, another type of reservoir could naturally be used, e.g. that does not include an outer pot 4. However, the outer pot makes it easy to give the reservoir a conventional pot shape, independently of the capacity and the shape of the inner container 1.

The lid 5 is mounted on the reservoir R, and more particularly on the neck 41 formed by the outer pot 4. To do this, the lid 5 includes a fastener ring 58 that is engaged, e.g. snap-fastened or screw-fastened, on the outside of the neck 41. Sealing may be guaranteed by a neck gasket 9 that is flattened between the lid and the reservoir, and more particularly on the top edge of the inner container 1, as can be seen clearly in FIG. 2. Inside the fastener ring 58, the lid 5 forms a wide annulus 56 that is substantially or completely plane. At the inside of the flat 56, the lid 5 forms an annular flange 55 that extends upwards. A movable member 51 is arranged inside the flange 55 with which it is connected by means of a plurality of resilient tabs or blades 54 that act as resilient means. As a result of the flexible tabs 54, the movable member 51 can move axially inside the flange 55. In greater detail, the movable member 51 includes a closure pin 52 that, in this embodiment, is in the shape of a bulge or of a rounded dome. Naturally, other shapes may be envisaged for the pin 52. Around the pin 52, the movable member 51 forms a cam member 53 that may comprise a plurality of identical cam profiles that are arranged in a circle, such that each cam profile extends over a circular arc, forming a gentle slope. This can be seen more clearly in FIG. 4. The movable member 51 is thus movable along an axis that is substantially perpendicular to the plane formed by the annular flat 56.

In the invention, the dispenser also includes a rotary disk 6 that is mounted on the lid 5 in such a manner as to be capable of turning about the pin 52. The disk is substantially or completely plane for the most part, except at its peripheral edge that forms a rim 68. It is also possible to envisage that the disk 6 presents a shape that is slightly concave, thereby defining a collection dish for collecting fluid. At its center, the disk 6 is perforated by a dispenser orifice 62 having an edge that forms a valve seat 63 having a shape that corresponds to the shape of the pin 52, so as to be able to achieve sealing contact between these two parts. It is even possible to envisage making the valve seat 63 out of a flexible material that is over-molded or bi-injected, for example. As can be seen in FIG. 5, the outside of the valve seat 63 is surrounded by a cam element 65 that presents a configuration that is complementary to the cam member 53 formed by the lid 53. More precisely, the cam element 65 may comprise a plurality of cam sectors each defining a slope in the shape of a circularly-arcuate segment. The number of cam sectors corresponds to the number of cam profiles of the cam member 53. The cam element 65 may thus be arranged on the cam member 53 in completely interleaved manner, so that contact is achieved over the entire periphery. This configuration corresponds to a closed position, as shown in FIG. 2. The pin 52 thus bears in sealed manner against the valve seat 63. Thus, it can readily be understood that turning the rotary disk 6 relative to the lid 5 causes the cam element 65 of the lid 6 to turn relative to the cam member 53 of the lid 5, thus forcing the movable member 51 to move towards the bottom or towards the inside of the reservoir R against the resilient means formed by the flexible tabs 54. The movement of the movable member 51 naturally causes the pin 52 to lift off, thus losing its sealing contact with the seat 63 in such a manner as to release the dispenser orifice 62. The fluid that is stored under pressure inside the reservoir can thus flow through the dispenser orifice so as to reach the top face of the disk 6, around the dispenser orifice. Fluid dispensing continues to take place so long as the disk 6 is held in this position.

In order to return the disk 6 into its initial start position, a return spring 7 is provided that acts between the disk 6 and the lid 5. The return spring 7, shown in FIGS. 4 and 5, advantageously presents a flat configuration so that it can be inserted in the small space defined between the lid 5 and the rotary disk 6. Advantageously, the return spring 7 is made of plastics material and presents elastic shape memory. By way of example, it is possible to make the spring 7 of zig-zag shape 71 that is provided at its two ends with socket caps 75 and 76 that are engaged on pins 57 and 67 that are formed by the lid 5 and the disk 6 respectively. The return spring limits the angular stroke of the disk, e.g. over an angle that is less than 90°, and returns the disk 6 or brings it back into its initial position once the user releases it. In order to inform the user that actuation of the dispenser requires the disk 6 to be turned, arrows 66 may be provided, arranged on an outer annulus 61 that is defined around the dispenser orifice 62, as can be seen in FIG. 4.

In order to hold the disk 6 on the lid 5 while enabling it to turn, initially a collar 64 is provided that extends around the cam member 65 and that is engaged, advantageously snap-fastened, around the annular flange 55 formed by the lid 5. Naturally, once the two elements are snap-fastened together, the disk 6 should be free to turn relative to the lid 5. In addition, a hoop 8 is also provided that comes into engagement around the fastener ring 58 with a bottom portion, and that also comes into engagement with the peripheral rim 68 of the lid 6 at a top portion 82 that advantageously extends over the disk 6. Here too, the presence of the hoop 8 should not prevent the disk 6 from turning relative to the lid 5. Without going beyond the ambit of the present invention, it is possible to omit the hoop 8: the disk 6 would thus be held on the lid 5 only by its collar 64 engaged around the flange 55. The inverse is also possible: the collar 64 could be omitted.

Implementing the present invention in the form of a pot fitted with a lid that is substantially flat and of considerable diameter makes it possible to use a rotary disk with a corresponding diameter, such that it creates a force-increasing effect, in so far as the disk is actuated in the proximity of its outer edge at a distance from the dispenser orifice. In addition, it should also be observed that the pressure exerted by the fluid does not degrade the sealing of the valve, given that the pressure of the fluid is exerted on the inside face of the movable member 51, which is thus pushed against the seat 63.

The present invention thus provides a dispenser, preferably in the form of a pot, that is closed by a lid and that is covered by a rotary disk that forms the dispenser orifice and that is turned in order to open the outlet valve.

1. A fluid dispenser comprising a fluid reservoir in which the fluid is stored under pressure, and a fluid outlet valve that is actuatable from a closed position to an open position so as to define a dispenser orifice, the outlet valve including a movable member that bears in sealed manner against a seat in the closed position and that is not in contact with the seat in the open position, the movable member being axially movable and resiliently biased against the seat, the dispenser also comprising an actuator member for moving the movable member between the closed and open positions, the fluid dispenser being characterized in that the dispenser orifice and the actuator member are both formed by a rotary disk.

2. The dispenser according to claim 1, wherein the rotary disk performs a limited angular stroke against a return spring.

3. The dispenser according to claim 1, wherein the rotary disk includes a cam element so as to transform the rotary movement of the disk into axial movement of the movable member.

4. The dispenser according to claim 3, wherein the cam element comprises a plurality of cam sectors, each defining a slope in the shape of a circularly-arcuate segment.

5. The dispenser according to claim 3, wherein the movable member is provided with a cam member that co-operates with the cam element of the rotary disk.

6. The dispenser according to claim 5, wherein the cam member defines as many circularly-arcuate cam profiles as there are cam sectors.

7. The dispenser according to claim 1, wherein the movable member is formed by a lid that is mounted on the reservoir, the rotary disk being rotatably mounted on the lid to turn about the movable member, the rotary disk advantageously being held on the lid by a hoop.

8. The dispenser according to claim 7, wherein a return spring that is advantageously flat and made of plastics material, acts between the rotary disk and the lid so as to return the rotary disk into its initial position after each turn.

9. The dispenser according to claim 7, wherein the movable member comprises a pin that is suitable for engaging in sealed manner in the seat that is formed by the rotary disk, the pin being surrounded by a cam member that is itself surrounded by resilient means, advantageously in the form of flexible tabs that urge the pin resiliently against the seat.

10. The dispenser according to claim 1, wherein the reservoir includes a pusher piston that slides in leaktight manner in a slide cylinder, the pusher piston being biased by resilient means selected from springs, foams, and gases.
